(19) United States
(12) Patent Application Publication
(10) Pub. No.: US 2026/0233068 A1
(43) Pub. Date: Aug. 13, 2026

(54) GOLF CLUB SHAFT STRUCTURE

(71) Applicant: XFiburst Tech. Co., Ltd., New Taipei City (TW)

(72) Inventor: Yi Hung Lin, New Taipei City (TW)

(21) Appl. No.: 19/464,656

(22) Filed: Jan. 30, 2026

(30) Foreign Application Priority Data
Feb. 13, 2025 (TW) 114201500

(51) Int. Cl. A63B 53/12; B32B 1/00; B32B 5/02; B32B 27/12; B32B 37/20; B32B 38/00

(52) U.S. Cl. CPC A63B 53/12; B32B 1/00; B32B 5/02; B32B 27/12; B32B 37/203; B32B 38/0036; A63B 2209/023; B32B 2038/0076; B32B 2260/023; B32B 2260/046; B32B 2262/103; B32B 2262/106; B32B 2307/7376; B32B 2363/00

(57) ABSTRACT

The present of invention provides a golf club shaft structure, characterized in that: the shaft structure comprises overlapping carbon fiber layers and at least one layer of plastic film, and/or a metal sheet with a thickness of less than 0.2 mm (200 micrometers; 0.0079 inches), each layer of material being covered by a matrix and formed by thermosetting. This combination of different materials in the shaft endows it with excellent elasticity, toughness, and shock absorption performance, thereby achieving better power transmission and control. This allows the golf club to provide easily controllable accuracy during long-distance swings or short-distance putting, and provides shock absorption and a unique feel for long-distance swings.

### CROSS REFERENCE TO RELATED APPLICATIONS

The present application is based on, and claims priority from, Republic of China Utility Model Patent Application No. 114201500, filed Feb. 13, 2025, the disclosure of which is hereby incorporated by reference herein in its entirety.

### BACKGROUND OF THE INVENTION

### Field of the Invention

The present invention generally relates to golf equipment and more particularly, to golf club shaft structure having the characteristics of metal, carbon fiber, and plastic materials to provide the golf club shaft of golf clubs with excellent elasticity, toughness, flexibility, shock absorption, unique hitting feel, and control.

### Description of Related Art

Golf is a sport that requires different techniques for different shots, and golf club heads also have different designs. For example, the shapes of golf club heads for “swinging” and “putting” are different. “Swinging” is used to land the ball on the green near the hole, while “putting” is used to push the ball, which is already close to the hole, into the hole. Therefore, the shapes of golf club heads are designed differently. Many innovative designs have been developed for this type of golf club heads. Furthermore, the golf club shaft of golf clubs has evolved from early single-material carbon fiber, which was then bonded together with a pre-impregnated thermosetting epoxy resin (Thermoset, TS) through heating to form a carbon fiber layer. Currently, multiple materials, including metal and carbon fiber, are used in the golf club shaft, and these designs are constantly being improved to provide golf enthusiasts with more diverse options.

However, when using the golf club shaft for “putting” and “swinging”, the user's own feel and force are very important for the accuracy and stability of ball control. In addition to frequent practice, the interaction between the materials of the golf club heads and shaft also has a direct impact. For example, a metal shaft is heavier, resulting in better rolling stability of the ball after the expected impact in both “putting” and “swinging” (but the ball's rolling or flight distance is shorter). If the golf club shaft is made of carbon fiber, it will be lighter, resulting in a greater distance the ball travels or flies after impact, whether in putting or swinging (but the ball's trajectory and rolling stability will be poorer). Based on this, it seems that choosing a suitable golf club shaft (metal or carbon fiber) according to one's own center of gravity and force in the hitting posture can achieve more ideal ball control. However, it is difficult for beginners who enjoy golf to choose a suitable golf club shaft (metal or carbon fiber) based on their own center of gravity and power in their swing. While experienced golfers can choose a golf club shaft that suits their needs, as the above mentioned, the use of metal or carbon fiber shafts makes it difficult to control the ball's roll after impact during the “putting” or “swing,” especially in terms of the stability, range, and accuracy of the ball's trajectory during the “swing.”

Furthermore, the aforementioned golf club shaft is made of metal and carbon fiber, which provides golfers with another option. On the surface, it seems to combine the characteristics of the ball's trajectory stability or range and accuracy during the “putting” or “swinging” process of the aforementioned metal and carbon fiber materials. However, this is not actually the case. The main reason is that the expansion coefficients of the carbon fiber layer and the metal layer of the composite material are very different. The large difference in volume change between the two materials leads to a relatively large increase in the interlayer separation stress between the different materials. As a result, interlayer separation will occur between the layers due to the different materials at the contact surface. This makes the bonding between the carbon fiber layer and the metal layer of the composite material unstable, causing a significant impact on performance. In severe cases, it may even endanger safety. Once a golf club has been used for a period of time, the powerful impact it experiences upon impact will cause significant stress. The high stress and intense impact of these impacts will cause a large difference in the coefficients of thermal expansion between the carbon fiber and metal layers. This difference in volume leads to amplified interlayer separation stress, resulting in separation at the contact surfaces between the carbon fiber and metal layers. Consequently, the entire golf club shaft becomes unusable. In short, the thickness of the metal layer in the golf club shaft directly affects the stability of the bond with the carbon fiber layer.

Furthermore, another type of golf club shaft, made of metal and carbon fiber, can be further understood with reference to FIG. 1. The structure of the golf club shaft 5 includes an inner carbon fiber layer 51 and an outer metal layer 52. The carbon fiber layer 51 is composed of a plurality of carbon fiber prepregs with different angles. The metal layer 52 is made by spirally winding metal wire around the outer surface of the carbon fiber layer 51. Therefore, the entire of the golf club shaft structure is not completely covered by the metal wire, forming a mesh-like metal layer 52. As a result, the carbon fiber layer 51 is not completely covered by the metal wire, resulting in mesh-like gaps in the metal layer 52. Once the ball is hit as intended during a “push” or “swing,” the ball's roll is difficult to control, especially the trajectory of the golf ball during the “swing.” The stability of the rolling motion, as well as the range and accuracy, are difficult to control. The main reason is that after the ball is hit, the force on the carbon fiber layer 51 of the entire of the golf club shaft 5 is only partially absorbed by the metal wire wrapped around the outer surface of the carbon fiber layer 51 by the metal layer 52. Most of the force is penetrated and burst out through the mesh gaps of the metal layer 52. It is like not “fully” placing a thermoplastic PVB film between two glass layers, but only adding a mesh-like structure between the layers with gaps. When impacted, it penetrates and bursts out, causing glass fragments to scatter everywhere. Therefore, the golf club shaft 5 described above cannot achieve the effect of effectively absorbing the impact force when the ball is hit by the metal wire added to the outer surface of the carbon fiber layer 51. The control effect on the golf ball is basically the same as before the metal wire was wrapped around it.

In addition, the golf club shaft 5 generate impact force during the swing, which often causes injuries to athletes. Therefore, traditional golf club grips already have related designs and technical documents for absorbing this impact force (shock absorption). However, golf club shafts do not have this shock absorption function. If the golf club shaft could be given shock absorption capabilities, it would further improve the overall shock absorption effect of the golf club shaft, as well as its unique hitting feel and control. Furthermore, Golf club shafts are traditionally made from a matrix, which consists of multiple layers of carbon fiber prepreg and thermosetting epoxy resin (TS), it do not meet environmental protection requirements and cannot be recycled. In addition, their elasticity, toughness, and shock absorption capabilities are not ideal and urgently need improvement.

In view of above mentioned, the inventor of the present invention has created the present invention based on his many years of experience in the research of composite materials.

### BRIEF SUMMARY OF THE INVENTION

An object of the present invention is to provide a golf club shaft structure that combines the characteristics of metal, carbon fiber, and plastic materials, providing the golf club shaft with excellent elasticity, toughness, flexibility, shock absorption, unique hitting feel, and control. Furthermore, the metal material uses a thin sheet design with a thickness of less than 0.2 mm (200 μm; 0.0079 inch) and an overlapping and complete coverage of carbon fiber layers. This effectively solves the problem of interlayer separation caused by the significant difference in the coefficients of thermal expansion between different materials. In other words, the golf club shaft structure in the present application, based on the existing all-carbon fiber material structure, replaces a certain proportion of the carbon fiber material with thin metal sheets. Due to the use of thin metal sheets, and the fact that the thickness of the metal sheets is much smaller than the thickness of the carbon fiber layers, the variation in the coefficient of volume expansion of each layer of the metal sheet is relatively small. Therefore, the interlayer delamination stress caused by the volume expansion between the carbon fiber layers and the metal sheets is also relatively small. The metal sheets do not significantly affect the stress of the overall structure, thus solving the interlayer delamination phenomenon caused by the large difference in the coefficients of volume expansion between the carbon fiber layers and the metal layers. Furthermore, the golf club shaft structure in the present application is formulated by adjusting the mixing ratio of carbon fiber and metal materials. Namely, due to the relatively small volume change of the metal sheet, when covering carbon fiber, the resulting interlayer separation stress is relatively small, effectively preventing interlayer separation between the contact surfaces of different materials (carbon fiber and metal). Conversely, an excessively thick metal layer cannot solve the significant impact caused by interlayer separation at the contact surfaces. In addition, the comprehensive coating of the carbon fiber material with this thin metal sheet provides more effective absorption of impact during the swing, unlike conventional methods where the impact is absorbed through gaps in the spiral-wound metal wire. This makes the swing distance and accuracy of the golf club easier to control. Furthermore, the thin-film design of this plastic material, with its isodirectional properties, good shock absorption, and excellent toughness, overcomes the limitations of unidirectional carbon fiber, which can only absorb impact in one direction. This more effectively disperses the impact force during the swing, giving the golf club shaft a comfortable feel, shock absorption, and improved control during the swing.

In order to achieve the above objectives, the present invention provides a golf club shaft structure characterized in that: the golf club shaft structure includes a carbon fiber layer and at least one plastic film, wherein the carbon fiber layer is at least one layer of carbon fiber prepreg, which overlaps and completely covers with the at least one layer plastic film each other, and the carbon fiber layer and each of the plastic film with a matrix in contact each other. After covering, the cross-section of the golf club shaft resembling the annual of a tree, and forming the golf club shaft by heating and curing.

As described above, the thickness of the carbon fiber layer is greater than the thickness of the plastic film; the matrix is made of thermosetting epoxy resin (Thermoset, TS) or thermoplastic (TP), and this plastic film is made of high-temperature resistant plastic film with a melting temperature (Tm) above 150° C.

As described above, the golf club shaft structure also includes at least one metal layer, which overlaps with a carbon fiber layer and a plastic film. These three layers are interconnected through a matrix and are then heat-cured, as needed, fixtures are used to pierce the overlapping carbon fiber layers and at least one metal plate in specific areas to facilitate airflow and pre-shape the initial shape of the golf club shaft. After molding, the cross-sectional structure of the entire of the golf club shaft resembles the annual rings of a tree. By combining the advantages and properties of different materials, the unique feel of the golf club shaft is enhanced, resulting in better shock absorption and more precise control.

As described above, the metal layer is a metal sheet, and the thickness of the carbon fiber layer is greater than the thickness of the metal sheet. The metal sheet can be selected from one of aluminum, aluminum alloy, copper, steel, titanium, titanium alloy, and magnesium-aluminum alloy, and its thickness is less than 0.2 mm (200 μm; 0.0079 inch). During the winding, heating and curing process, the carbon fiber layer and plastic film of the entire of the golf club shaft are fully covered, so that the transverse cross section of the entire of the golf club shaft is similar to the annual rings of a tree.

As described above, the optimal thickness for each metal sheet is 0.004 mm (4 μm; 0.00016 inch) to 0.006 mm (6 μm; 0.00024 inch).

Another feature of the golf club shaft structure of the present invention is that the golf club structure includes a carbon fiber layer and at least one metal sheet, wherein the carbon fiber layer is at least one layer of carbon fiber prepreg, which overlaps and completely covers with the at least one layer metal sheet having a thickness of less than 0.2 mm (200 μm; 0.0079 inch) each other, and the carbon fiber layer and each of the metal sheet with a matrix in contact each other, and as needed, fixtures are used to pierce the overlapping carbon fiber layers and at least one metal plate in specific areas to facilitate airflow and pre-shape the initial shape of the golf club shaft. After covering, the cross-section of the golf club shaft resembling the annual of a tree, and forming the golf club shaft by heating and curing.

As described above, the thickness of the carbon fiber layer is greater than the thickness of the metal sheet; the matrix is made of thermosetting epoxy resin (TS) or thermoplastic (TP).

According to the above, the metal sheet can be selected from aluminum, aluminum alloy, copper, steel, titanium, titanium alloy, and magnesium-aluminum alloy, and its thickness is less than 0.2 mm (200 μm; 0.0079 inch), and it completely covers the carbon fiber layer and the matrix of the entire of the golf club shaft.

As described above, the optimal thickness for each metal sheet is 0.004 mm (4 μm; 0.00016 inch) to 0.006 mm (6 μm; 0.00024 inch).

Another feature of the golf club shaft structure of the present invention is that the golf club structure includes a carbon fiber layer and at least one layer of metal mesh, wherein the carbon fiber layer is at least one layer of carbon fiber prepreg, which overlaps with the at least one layer of the metal mesh, and the carbon fiber layer and each of the metal mesh with a matrix which is made of thermoplastic (TP) in contact each other. After molding, the cross-sectional structure of the entire of the golf club shaft resembles the annual rings of a tree, and is heated and cured to form the golf club shaft. Since the thermoplastic (TP) material with plastic material properties make it difficult to fix and adhere to the metal surface of the metal mesh. At this time, the metal mesh properties are used and heated at high temperature to completely melt the thermoplastic plastic to a highly viscoelastic liquid state, which penetrates through the gaps in the metal mesh and can be tightly connected and fixed to the carbon fiber material to form a whole.

### BRIEF DESCRIPTION OF THE DRAWINGS

FIG. 1 is a schematic diagram of a conventional golf club shaft, which is made of metal wire wound around the surface of a carbon fiber.

FIGS. 2 and 2A-2B are perspective views of a golf club shaft structure of the present invention, which is assembled with the iron head and grip, a perspective view of the golf club shaft assembled with the wood head, and a plan view of the golf club shaft assembled with the putter head.

FIGS. 3 and 4 are cross-sectional views of the first and second embodiments of the golf club shaft structure of the present invention.

FIGS. 5 and 6 are cross-sectional views of the third and fourth embodiments of the golf club shaft structure of the present invention.

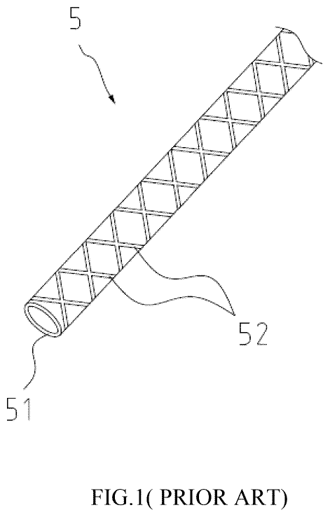

### DETAILED DESCRIPTION OF THE INVENTION

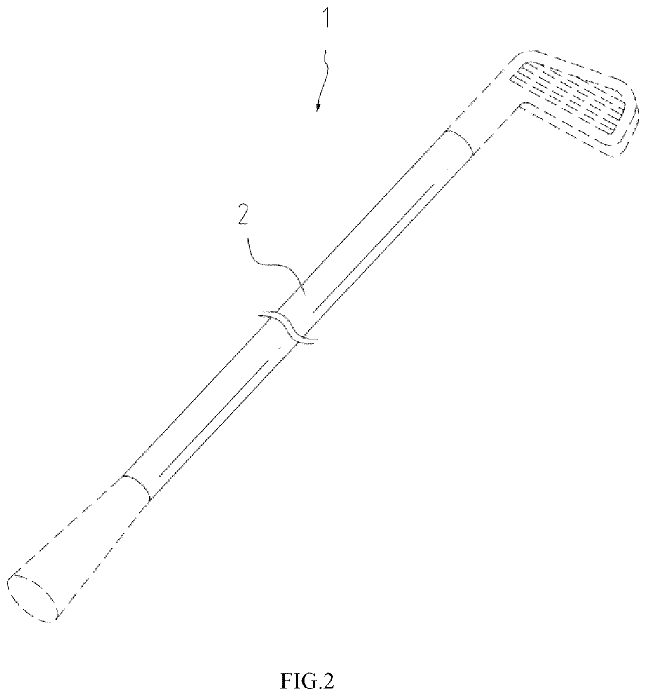

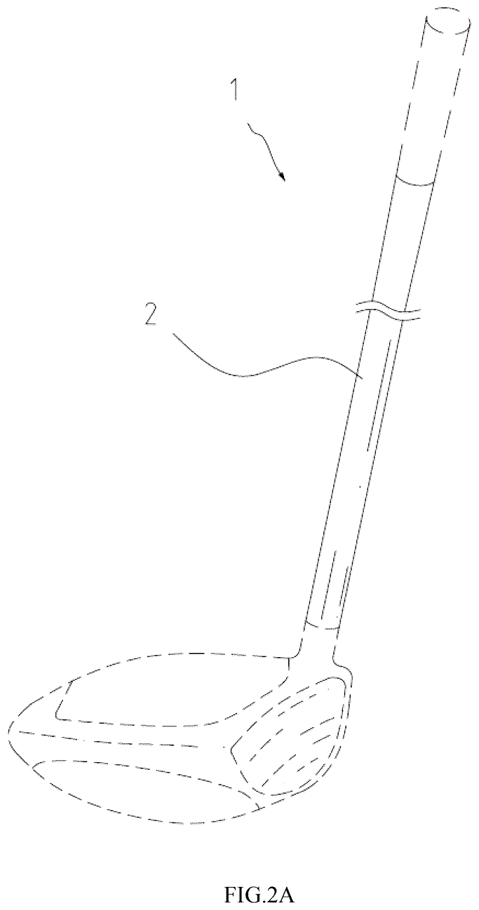

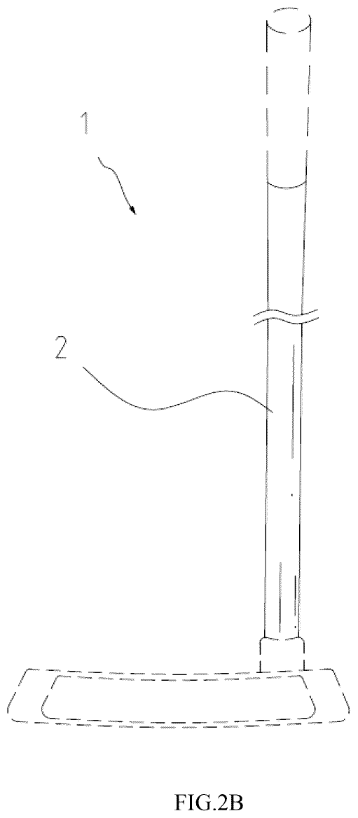

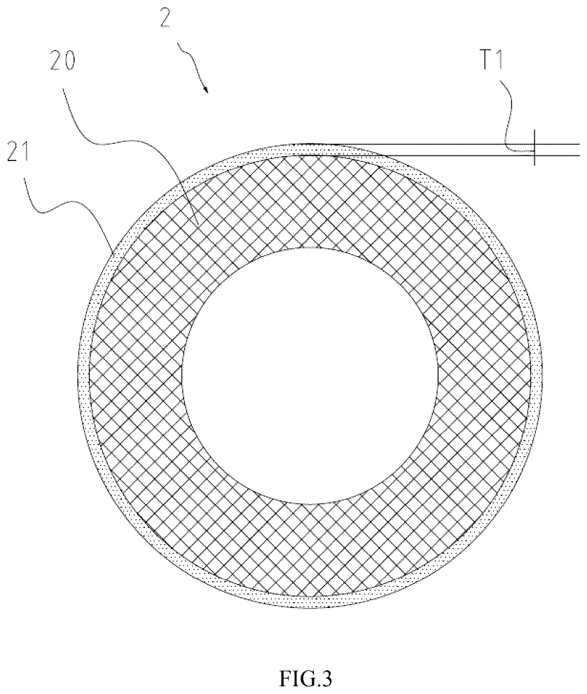

Please refer to FIGS. 2 and 2A-2B to view perspective views of the golf club structure of the present invention, the assembled iron head and grip, the assembled driver head and the assembled putter head. As shown in the figures, the golf club 1 has the golf club structure of the present invention. The golf club shaft 2, as shown in FIG. 3 (It's a first embodiment of the present invention), includes a carbon fiber layer 20 and a plastic film 21. The thickness of the carbon fiber layer 20 is greater than that of the plastic film 21. The carbon fiber layer 20 is at least one layer of carbon fiber prepreg that has been layered and wound, and is layered with the plastic film 21. Each material layer is covered by a matrix (not shown in the figure). Through the winding process, each carbon fiber layer 20 and the plastic film 21 can be fused together, and then the golf club shaft 2 is formed by heating and curing. The aforementioned matrix is made of thermosetting epoxy resin (TS) or thermoplastic (TP). As each of the aforementioned material layers is in contact with and covered by the matrix, each layer of carbon fiber prepreg is heated and wound into a carbon fiber layer 20 with good elasticity and toughness through a winding process. During the winding process, the plastic film 21 is added. The plastic film 21 is a plastic film with a high-temperature melting point (Tm) of 150° C. or higher, such as PVB film, PEEK plastic film, PC plastic film, or PI thermosetting film, and each of these plastic film thickness T1 is less than 0.2 mm (200 μm; 0.0079 inch), preferably 0.004 mm (4 μm; 0.00016 inch) to 0.006 mm (6 μm; 0.00024 inch). When the plastic film 21 comes into contact with the carbon fiber layer 20 of the entire of the golf club shaft 2 and is heated and cured, the transverse cross-section of the entire of the golf club shaft 2 after processing resembles an annual ring structure. This gives the golf club shaft 2 excellent elasticity, toughness, and shock absorption, making the golf club 1 more shock-absorbing and providing a unique feel for long-range swings. It is worth mentioning that since the thermoplastic (TP) Matrix is a recyclable material with strong shock absorption, elasticity, and toughness, the golf club structure in the first embodiment does not include the plastic film. Instead, multiple layers of carbon fiber prepreg are overlapped, with each layer of prepreg coated with the thermoplastic (TP) Matrix, and then heated and cured to form the golf club shaft. In this way, the golf clubs shaft of the present invention can also be endowed with excellent elasticity, toughness, and shock absorption, making them more shock-absorbing and providing a unique feel for long-range swings.

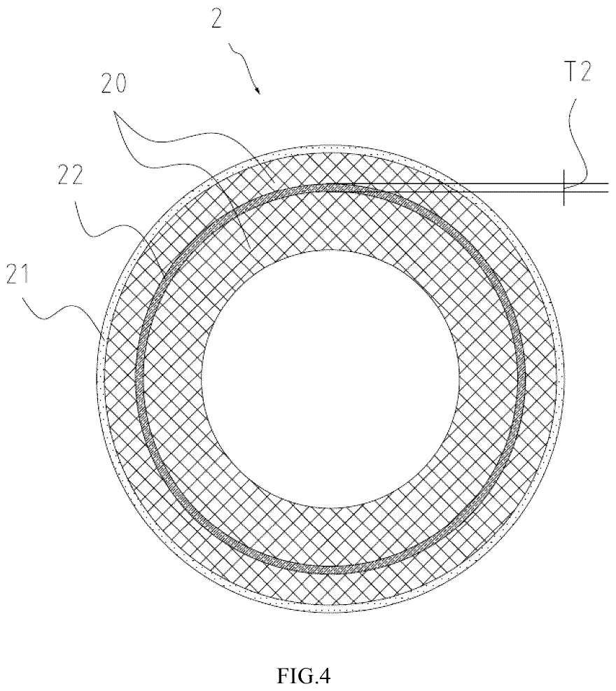

Please refer further to FIG. 4, which shows a second embodiment of the golf club structure of the present invention, the structure of the golf club shaft 2 in the second embodiment is similarly as that in the first embodiment. In addition to the functions provided by the structural features of the first embodiment, the second embodiment can further improve the structural function of the entire of the golf club shaft. As shown in FIG. 4, the golf club shaft 2 in the second embodiment also includes: a carbon fiber layer 20 and a plastic film 21, and further includes a metal sheet 22. The carbon fiber layer 20 is at least one layer of carbon fiber prepreg that has been layered and wound. The plastic film 21 is a plastic film with a high-temperature melting point (Tm) of 150° C. or higher. The metal sheet 22 is selected from aluminum, aluminum alloy, copper, steel, titanium, titanium alloy, and magnesium-aluminum alloy, and its thickness T2 is less than 0.2 mm (200 μm; 0.0079 inch), preferably 0.004 mm (4 μm; 0.00016 inch)~0.006 mm (6 μm; 0.00024 inch). The overall thickness is less than that of the carbon fiber layer 20. Each of these layer is covered by a matrix (not shown in FIG. 4), and as needed, fixtures are used to pierce the overlapping carbon fiber layers 20 and at least one metal plate 22 in specific areas to facilitate airflow and pre-shape the initial shape of the golf club shaft. After molding, the cross-sectional structure of the entire of the golf club shaft resembles the annual rings of a tree. Through the winding process, each carbon fiber layer 20 can be integrated with the plastic film 21 and the metal sheet 22. Then, it is heated and cured to form a complete the golf club shaft 2. In other words, the thin design of the metal sheet 22 (T2) can make the bonding between the layers of each carbon fiber layer 20 and the metal sheet 22 stable. It will not cause the interlayer peeling stress between different materials to be maximized. This will prevent interlayer peeling between the layers of each carbon fiber layer 20 and the metal sheet 22 at the contact surface, thus avoiding significant performance impact.

Therefore, by designing the thickness T2 of each metal sheet 22 on the golf club shaft 2 to be ultra-thin, the total thickness is less than the thickness of the carbon fiber layer 20, the difference in the coefficient of thermal expansion between the carbon fiber layer 20 and the metal sheet 22 is relatively small, resulting in a relatively small change in the volume of the metal sheet 22. Therefore, the interlayer peeling stress caused by the volume change of the carbon fiber layer 20 and the metal sheet 22 is also relatively smaller, making the bonding between the layers of the carbon fiber layer 20 and the metal sheet 22 of each layer stable. This prevents the interlayer peeling stress between the layers of different materials from being maximized, so that the interlayer peeling phenomenon between the layers of the carbon fiber layer 20 and the metal sheet 22 of each layer will not occur at the contact surface, thus avoiding significant performance impact. Conversely, using excessively thick metal layers cannot solve the significant impact caused by interlayer delamination at the contact surface. Therefore, in this invention, the metal sheet 22 is thinner (T2) and its overall thickness is less than that of the carbon fiber layer 20, which ensures a stable bond between the carbon fiber layer 20 and the metal sheet 22. Thus, in the second embodiment, the golf club shaft 2 is constructed by overlapping the carbon fiber layer 20, the plastic film 21, and the metal sheet 22, with each layer covered by a matrix (TS/TP). After covering, the cross-sectional structure of the entire shaft resembles tree rings. Through heat curing, the shaft 2 gains better elasticity and toughness, providing easy-to-control precision for long-range swings or short-range putting, as well as shock absorption and a unique hitting feel.

Therefore, as above described in FIGS. 3 and 4, the structure of the golf club shaft 2 of the golf club combines the advantages of multiple different materials such as carbon fiber, plastic, and metal, which can give the golf club shaft 2 good elasticity and strong toughness, making the distance and accuracy of the swing process easy to control, and providing shock absorption and a unique hitting feel for the long swing. That is, the structure of the golf club shaft 2 of the present invention is fully covered by the carbon fiber layer 20 and the metal sheet 22, which can provide easy control of the ball roll after the expected impact during the “putting” or “swing”, especially the trajectory roll stability or distance and accuracy during the “swing” process. The plastic film 21 can give the golf club shaft 2 good elasticity, strong toughness, excellent shock absorption and a unique hitting feel, so that the golf club 1 can provide shock absorption for the long swing, giving the golf club shaft 2 a comfortable and unique hitting feedback effect when holding the “swing”.

Furthermore, the metal layer of the golf club shaft in the present invention can also be a metal mesh. The metal mesh structure increases the surface adhesion and fixation force between the thermoplastic (TP) and carbon fiber. That is, the golf club structure of the present invention includes a carbon fiber layer and at least one layer of metal mesh. The carbon fiber layer is also at least one layer of carbon fiber prepreg, overlapping with the at least one layer of metal mesh, and each material layer is covered by thermoplastic (TP) in contact with it. Since the matrix material itself is not easily bonded to the metal surface due to its plastic properties, the metal mesh structure allows for high-temperature heating to completely melt the thermoplastic into a highly viscoelastic liquid state, penetrating through the gaps in the metal mesh and tightly bonding and fusing with the carbon fiber material. This results in a golf club shaft of the golf club with excellent elasticity and toughness, providing shock absorption and good flexibility.

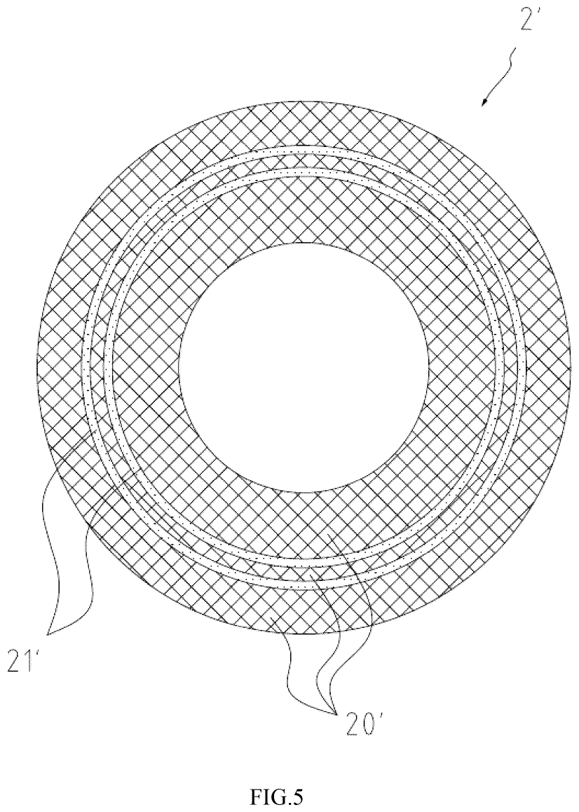

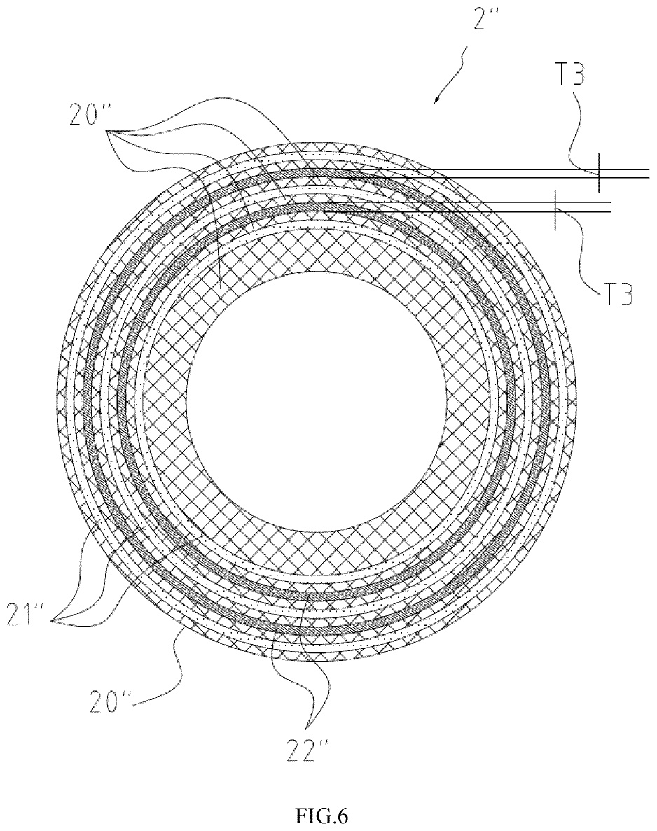

Please refer to FIGS. 5 and 6 for cross-sectional views of the third and fourth embodiments of the golf club structure of the present invention. As shown in FIG. 5, the structure of the golf club shaft 2′ of the present invention is mainly derived from the first embodiment in FIG. 3. The plastic film 21′ is placed in two or more layers inside the carbon fiber layer 20′. That is, the winding thermosetting process makes the carbon fiber layer 20′ the outermost layer of the golf club shaft 2′, and its thickness T1 is the same as that in FIG. 3 above, which is less than 0.2 mm (200 μm; 0.0079 inch), and preferably 0.004 mm (4 μm; 0.00016 inch)~0.006 mm (6 μm; 0.00024 inch). Similarly, FIG. 6 shows the structure of the golf club shaft 2″ of the present invention, which is mainly derived from variations of different embodiments of FIGS. 3 and 4. The plastic film 21″ nd the metal sheet 22″ re arranged in multiple layers with alternating spacing within the carbon fiber layer 20″. The thickness T3 of the metal sheet 22″ is less than 0.2 mm (200 μm; 0.0079 inch), preferably 0.004 mm (4 μm; 0.00016 inch) ~0.006 mm (6 μm; 0.00024 inch). The overall thickness is less than that of the carbon fiber layer 20. That is, the plastic film 21″ nd the metal sheet 22″ re wound successively during the winding thermosetting process, and the carbon fiber layer 20″ is located on the outermost layer of the golf club shaft 2″. As such, the cross-sections of FIGS. 5 and 6 can better show a structure similar to tree rings. The thinning design of the metal sheet 22″ allows for a stable bond between each of the carbon fiber layer 20″ nd the metal sheet 22″, preventing the interlayer peeling stress between different materials from being maximized. This ensures that there is no interlayer peeling between each of the carbon fiber layer 20″ and the metal sheet 22″ at the contact surface, which would cause significant performance impact. Therefore, the golf club shaft 2″ of the present invention is given excellent elasticity and toughness, as well as shock absorption and a unique hitting feel. This gives the golf club shaft 2″ comfortable hitting feedback, shock absorption effect and control effect when holding and swinging.

In summary, the golf club structure of the present invention can indeed achieve the purpose of the invention and meets the requirements of the patentability. However, the above description is only a preferred embodiment of the present invention. All modifications and variations made based on the present invention, such as the golf club shaft of the present invention being composed of multiple layers of plastic film, metal sheet and carbon fiber layer, and the outermost layer of the golf club shaft being various overlapping states of metal sheet or plastic film, should still be included in the scope of patent of the present application.

What is claimed is:

1. A golf club shaft structure comprising a carbon fiber layer and at least one layer plastic film, the carbon fiber layer having at least one layer of carbon fiber prepreg, and overlapping and completely covering with the at least one layer plastic film each other, and the carbon fiber layer and each of the plastic film with a matrix in contact each other, after covering, the cross-section of the golf club shaft resembling the annual of a tree, and forming the golf club shaft by heating and curing.

2. The golf club shaft structure as described in claim 1, wherein the thickness of the carbon fiber layer is greater than the thickness of the plastic film.

3. The golf club shaft structure as described in claim 2, wherein the plastic film is made of high-temperature resistant plastic film with a melting temperature (Tm) above 150° C.

4. The golf club shaft structure as described in claim 3, wherein the matrix is made of thermosetting epoxy resin (Thermoset, TS) or thermoplastic (TP).

5. The golf club shaft structure as described in claim 4, wherein the golf club shaft structure further includes at least one metal layer, which is overlapped with the carbon fiber layer and the plastic film. These three layers are interconnected by the matrix, and formed by heating and curing, after molding, the cross-sectional structure of the entire of the golf club shaft resembles the annual rings of a tree.

6. The golf club shaft structure as described in claim 4, wherein the thickness of the plastic film is less than 0.2 mm (200 μm; 0.0079 inch) and completely covers the carbon fiber layer of the entire of the golf club shaft, and the transverse cross section of the entire of the golf club shaft is similar to the annual rings of a tree.

7. The golf club shaft structure as described in claim 6, wherein the optimal thickness for each layer of plastic film is preferably 0.004 mm (4 μm; 0.00016 inch) to 0.006 mm (6 μm; 0.00024 inch).

8. The golf club shaft structure as described in claim 5, wherein the metal layer is a metal sheet, and the thickness of the carbon fiber layer is greater than the thickness of the metal sheet, the metal sheet can be selected from one of aluminum, aluminum alloy, copper, steel, titanium, titanium alloy, and magnesium-aluminum alloy, and its thickness is less than 0.2 mm (200 μm; 0.0079 inch), during the winding, heating and curing process, the carbon fiber layer and plastic film of the entire of the golf club shaft are fully covered, after molding, the cross-sectional structure of the entire of the golf club shaft resembles the annual rings of a tree.

9. The golf club shaft structure as described in claim 8, wherein the thickness of the carbon fiber layer is greater than the thickness of the metal sheet.

10. The golf club shaft structure as described in claim 7, wherein the optimal thickness for each metal sheet is 0.004 mm (4 μm; 0.00016 inch) to 0.006 mm (6 μm; 0.00024 inch).

11. The golf club shaft structure as described in claim 5, wherein the metal layer is a metal mesh, which overlaps with the carbon fiber layer and plastic film, these three layers are interconnected through the matrix and are then heat-cured, after molding, the cross-sectional structure of the entire of the golf club shaft resembles the annual rings of a tree.

12. A golf club shaft structure comprising a carbon fiber layer and at least one layer metal sheet, the carbon fiber layer having at least one layer of carbon fiber prepreg, and overlapping and completely covering with the at least one layer metal sheet having a thickness of less than 0.2 mm (200 μm; 0.0079 inch) each other, and the carbon fiber layer and each of the metal sheet with a matrix in contact each other, after covering, the cross-section of the golf club shaft resembling the annual of a tree, and forming the golf club shaft by heating and curing.

13. The golf club shaft structure as described in claim 12, wherein the thickness of the carbon fiber layer is greater than the thickness of the metal sheet.

14. The golf club shaft structure as described in claim 13, wherein the matrix is made of thermosetting epoxy resin (TS) or thermoplastic (TP).

15. The golf club shaft structure as described in claim 14, wherein the metal sheet may be selected from one of aluminum, aluminum alloy, copper, steel, titanium, titanium alloy, and magnesium-aluminum alloy, and is used to completely cover the carbon fiber layer of the entire of the golf club shaft, after molding, the cross-sectional structure of of the golf club shaft resembling the annual rings of a tree.

16. The golf club shaft structure as described in claim 12, wherein the thickness of each metal sheet is preferably 0.004 mm (4 μm; 0.00016 inch) to 0.006 mm (6 μm; 0.00024 inch).

17. A golf club shaft structure comprising a carbon fiber layer and at least one layer metal mesh, the carbon fiber layer having at least one layer of carbon fiber prepreg, and overlapping with the at least one layer metal mesh each other, and the carbon fiber layer and each of the metal mesh with a matrix which is made of thermoplastic (TP) in contact each other, and forming the golf club shaft by heating and curing.
